(19) United States
(12) Patent Application Publication
(10) Pub. No.: US 2012/0327551 A1
(43) Pub. Date: Dec. 27, 2012

(54) ENERGY STORAGE DEVICE AND MANUFACTURING METHOD THEREOF, AND UNIT CELL FOR ENERGY STORAGE DEVICE

(75) Inventors: Chan YOON, Seoul (KR); Hyun Chul Jung, Gyeonggi-do (KR); Young Hak Jeong, Gyeonggi-do (KR); Bae Kyun Kim, Gyeonggi-do (KR)

(73) Assignee: SAMSUNG ELECTRO-MECHANICS CO., LTD., Suwon (KR)

(21) Appl. No.: 13/467,548

(22) Filed: May 9, 2012

(30) Foreign Application Priority Data
Jun. 27, 2011 (KR) 10-2011-0062444

(51) Int. Cl. H01G 4/30

(52) U.S. Cl. 361/301.4; 29/25.41

(57) ABSTRACT

An energy storage device includes a plurality of unit cells stacked therein, each of the unit cells including a cell body, a positive terminal disposed at one side of the cell body, and a negative terminal disposed in the cell body to form a constant rotation angle with the positive terminal with reference to a center of the cell body, wherein the plurality of cell units are stacked in such a manner that another unit cell is rotated as much as the constant rotation angle with reference to one unit cell. Temperature distribution, that is, heat distribution in the energy storage device can be kept even, and heat transmission efficiency between the terminals and the external air can be improved and thus cooling efficiency can be improved. Also, a resistance value is reduced by improving a cooling function so that performance and reliability of a product can be improved.

### CROSS REFERENCE(S) TO RELATED APPLICATIONS

This application claims the benefit under 35 U.S.C. Section 119 of Korean Patent Application Serial No. 10-2011-0062444, entitled “Energy Storage Device and Manufacturing Method Thereof, and Unit Cell for Energy Storage Device” filed on Jun. 27, 2011, which is hereby incorporated by reference in its entirety into this application.

### BACKGROUND OF THE INVENTION

1. Technical Field

The present invention relates to an energy storage device, and more particularly, to an energy storage device that has even temperature distribution over all of the stacked unit cells, and efficiently transmits heat between a positive terminal and a negative terminal and external air, thereby improving cooling efficiency and thus improving performance and reliability of the energy storage device, and a manufacturing method thereof, and a unit cell for an energy storage device.

2. Description of the Related Art

In general, an electrochemical energy storage device is a core part of a finished product, which is essentially used in all mobile information communication devices and electronic devices. Also, the electrochemical energy storage device will definitely be used as a high quality energy source as a new regeneration energy field which may be applied to electric cars and mobile electronic devices of the future.

An electrochemical capacitor of the electrochemical energy storage device may be divided into an electrical double layer capacitor using an electrical double layer principle and a hybrid super capacitor using an electrochemical oxidation-reduction reaction.

The electrical double layer capacitor is being increasingly used in a field that requires a high output energy characteristic, but has a problem such as a small capacity. On the other hand, the hybrid super capacitor has been researched as a new alternative method to enhance the capacity characteristic of the electrical double layer capacitor. In particular, a lithium ion capacitor (LIC) of the hybrid super capacitor may have a storage capacity 3 to 4 times higher than that of the electrical double layer capacitor.

Hereinafter, a unit cell of a related art energy storage device such as an electrochemical capacitor will be explained.

As shown in FIG. 1, a unit cell 10 for a related art energy storage device includes a cell body 13 which includes a positive terminal 11 and a negative terminal 12.

More specifically, the cell body 13 is formed by alternately stacking a cathode and an anode having the positive terminal 11 and the negative terminal 12, respectively, and further includes a separator to electrically separate the cathode from the anode.

The positive terminal 11 and the negative terminal 12 are disposed at one side of the cell body 13 in parallel to each other.

As shown in FIG. 2, an energy storage device 1 is configured by stacking a plurality of unit cells 10 having the above constitution and modularizing the unit cells 10.

In the related art energy storage device 1, the plurality of unit cells 10 are stacked in such a manner that a negative terminal of an upper unit cell is connected to a positive terminal of a lower unit cell. In other words, the plurality of unit cells 10 are stacked in such a manner that terminals of different polarities are connected alternately in a stacking direction, and thus, the plurality of unit cells are connected in series and are configured as an energy storage device that can store a voltage corresponding to a required voltage.

However, since electric conductivities of the positive terminal 11, the negative terminal 12, and the cell body 13 of the unit cell 10 are different, temperature distribution over all of the unit cells is uneven, and accordingly, if an energy storage device 1 is configured by stacking the plurality of unit cells 10, the uneven temperature distribution problem still remains, and the highest temperature is greatly different from the lowest temperature as shown in FIG. 2, and thus there is a problem in that performance of the unit cell and the energy storage device deteriorates.

### SUMMARY OF THE INVENTION

The present invention has been developed in order to solve the above problems, and an object of the present invention is to provide an energy storage device, which can make temperature distribution over stacked unit cells even, and a manufacturing method thereof, and a unit cell for an energy storage device.

Another object of the present invention is to provide an energy storage device, which has a positive terminal and a negative terminal arranged therein in all directions so that heat transmission between the terminals and external air can be efficiently achieved, and a manufacturing method thereof, and a unit cell for an energy storage device.

Still another object of the present invention is to provide an energy storage device, which improves performance and reliability of a product by improving a cooling operation and reducing a resistance value, and a manufacturing method thereof, and a unit cell for an energy storage device.

According to an exemplary embodiment of the present invention, there is provided an energy storage device including a plurality of unit cells stacked therein, each of the unit cells including a cell body, a positive terminal disposed at one side of the cell body, and a negative terminal disposed in the cell body to form a constant rotation angle with the positive terminal with reference to a center of the cell body, wherein the plurality of cell units are stacked in such a manner that another unit cell is rotated as much as the constant rotation angle with reference to one unit cell.

A positive terminal of the one unit cell may be connected to a negative terminal of the another unit cell in series, or a negative terminal of the one unit cell may be connected to a positive terminal of the another unit cell in series.

When the another unit cell is rotationally stacked with reference to the one unit cell as much as the constant rotation angle, the cell body of the unit cell may be designed such that a cell body of the one unit cell and a cell body of the another unit cell coincide with each other in a stacking direction. For example, the cell body of the unit cell may have a square shape or a circular shape.

The rotation angle may be 90 degrees. In other words, the rotation angle between the positive terminal and the negative terminal may be 90 degrees with reference to the center of the cell body.

The cell body may include a cathode and an anode stacked in sequence with a separator therebetween, and the cathode and the anode may include the positive terminal and the negative terminal, respectively.

The cathode may include a positive current collector and a positive active material layer disposed on each of opposite surfaces of the positive current collector, and the anode may include a negative current collector and a negative active material layer disposed on each of opposite surfaces of the negative current collector.

According to another exemplary embodiment of the present invention, there is provided a unit cell for an energy storage device, the unit cell including a cell body, a positive terminal disposed at one side of the cell body, and a negative terminal disposed in the cell body to form a constant rotation angle with the positive terminal with reference to a center of the cell body, wherein the unit cell for the energy storage device configures an energy storage device by stacking a plurality of unit cells in such a manner that another unit cell is rotated as much as the constant rotation angle with reference to one unit cell.

According to still another exemplary embodiment of the present invention, there is provided a method for manufacturing an energy storage device in which a plurality of unit cells are stacked, each of the plurality of unit cells including a cell body, a positive terminal disposed at one side of the cell body, and a negative terminal disposed in the cell body to form a constant rotation angle with the positive terminal with reference to a center of the cell body, the method including stacking the plurality of unit cells in such a manner that another unit cell is rotated as much as the constant rotation angle with reference to one unit cell.

### BRIEF DESCRIPTION OF THE DRAWINGS

FIG. 1 is a perspective view schematically illustrating a unit cell for a related art energy storage device;

FIG. 2 is a perspective view and a temperature distribution graph illustrating a related art energy storage device in which a plurality of unit cells for the energy storage device are stacked, and also illustrating temperature distribution as a result of a simulation;

FIG. 3 is a perspective view schematically illustrating a unit cell for an energy storage device according to an exemplary embodiment;

FIG. 4 is an assembly perspective view schematically illustrating an energy storage device according to an exemplary embodiment;

FIG. 5 is an exploded perspective view schematically illustrating the energy storage device according to the exemplary embodiment; and

FIG. 6 is a view illustrating temperature distribution as a result of a simulation of the energy storage device according to the exemplary embodiment.

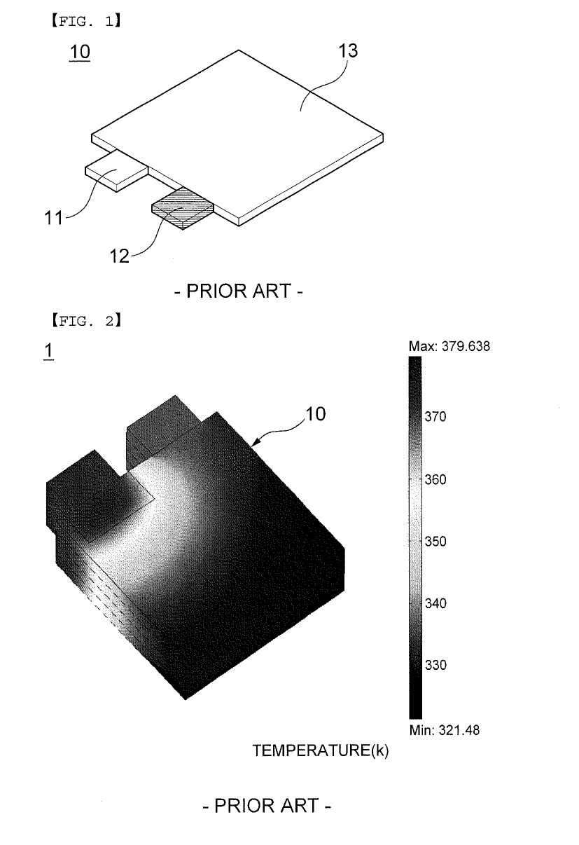

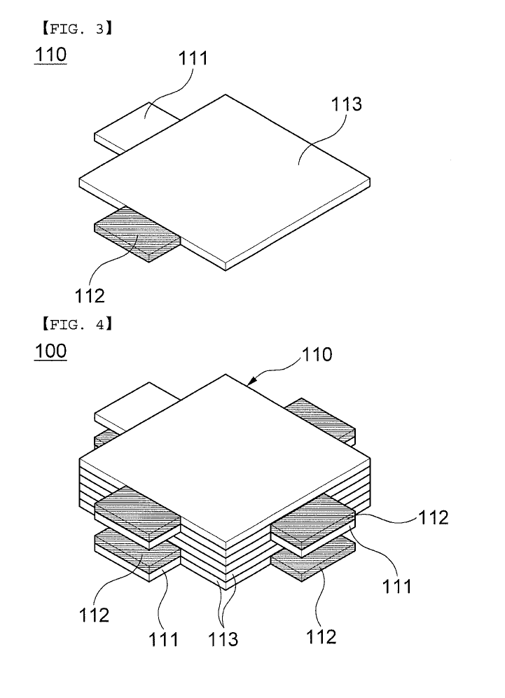

### DESCRIPTION OF THE PREFERRED EMBODIMENTS

Hereinafter, exemplary embodiments will be described in greater detail with reference to the accompanying drawings. In the following descriptions, same reference numerals and signs are used for the same elements when they are depicted in different drawings and an additional description thereof will be omitted.

Hereinafter, a unit cell for an energy storage device and an energy storage device including the same will be explained in more detail with reference to FIGS. 3 to 6.

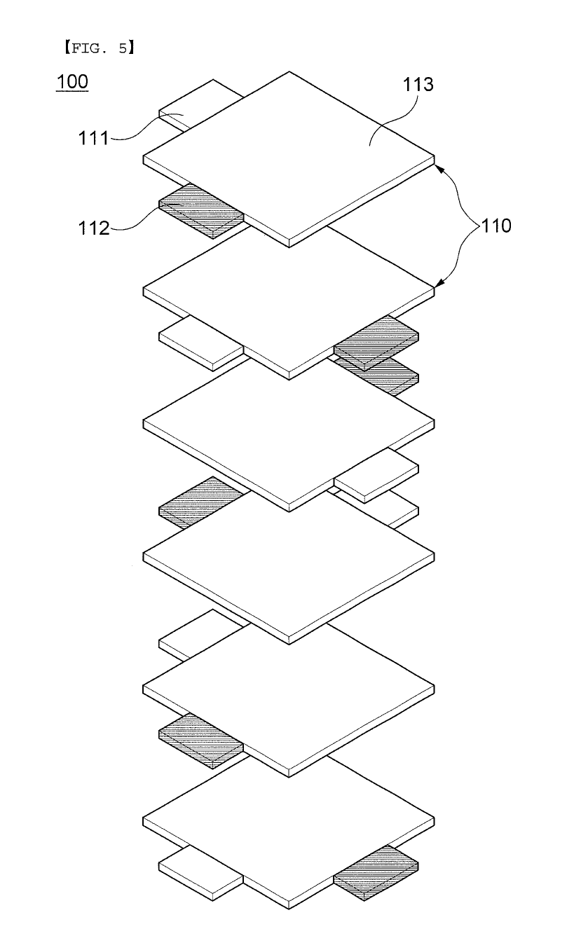

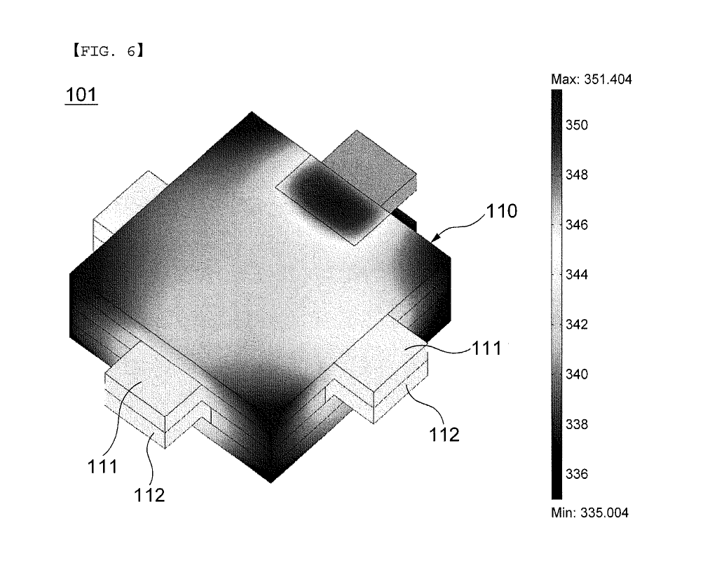

FIG. 3 is a perspective view schematically illustrating a unit cell for an energy storage device according to an exemplary embodiment, FIG. 4 is an assembly perspective view schematically illustrating an energy storage device according to an exemplary embodiment, FIG. 5 is an exploded perspective view schematically illustrating the energy storage device according to the exemplary embodiment, and FIG. 6 is a view illustrating temperature distribution as a result of a simulation of the energy storage device of the exemplary embodiment.

As shown in FIG. 3, a unit cell 110 for an energy storage device according to an exemplary embodiment includes a positive terminal 111, a negative terminal 112, and a cell body 113.

The positive terminal 111 and the negative terminal 112 may be disposed in the cell body 113 to form a constant rotation angle with reference to a center of the cell body 113.

For example, the rotation angle may be 90 degrees. In other words, the rotation angle between the positive terminal 111 and the negative terminal 112 with reference to the center of the cell body 113 may be 90 degrees, and accordingly, the cell body 113 may have a rectangular shape, but this should not be considered as limiting.

If the cell body 113 has a rectangular shape, the positive terminal 111 and the negative terminal 112 may be disposed on one side surface of the cell body 113 and on another side surface adjacent to the one side surface, respectively, and accordingly, the positive terminal 111 and the negative terminal 112 form the rotation angle of 90 degrees with reference to the center of the cell body 113.

As another example, if the cell body 113 has a circular shape, the positive terminal 111 and the negative terminal 112 are disposed around a circumference of the cell body 113 to have various rotation angles other than 90 degrees.

Referring to FIGS. 4 and 5, in an energy storage device 100 according to an exemplary embodiment, a plurality of unit cells 110 having the above-described constitution are stacked. When the plurality of unit cells 110 are stacked, another unit cell is rotationally stacked on one unit cell at the constant rotation angle with reference to the one unit cell.

Herein, when another unit cell is rotationally stacked on one unit cell at the constant rotation angle, rotation-stacking may be achieved in a clockwise direction or a counter clockwise direction.

More specifically, when the unit cells 110 are stacked upwardly, another unit cell is rotationally stacked on a top of one unit cell in the clockwise direction, so that a negative terminal of another unit cell is connected to a positive terminal of one unit cell in series. However, this should not be considered as limiting. Another unit cell may be rotationally stacked on the top of one unit cell in the counter clockwise direction, so that a positive terminal of another unit cell is connected to a negative terminal of one unit cell in series.

At this time, the cell body of the unit cell may be shaped in such a manner that a cell body of one unit coincides with a cell body of another unit cell in a stacking direction when another unit cell is rotationally stacked on one unit cell at the constant rotation angle. In other words, it is preferable that the cell body of the unit cell has a square shape, but the cell body of the unit cell may have a circular shape as described above.

In the above-described embodiment, since the energy storage device 100 is configured such that the unit cells 110 are rotationally stacked at the constant rotation angle, even if the unit cell 110 has uneven temperature distribution, the entire energy storage device 100 can have even temperature distribution.

That is, by rotating the unit cells 110 at the constant rotation angle when stacking the unit cells 110, a high temperature portion and a low temperature portion in the energy storage device 100 overlap with each other in the stacking direction, and as a result, the temperature distribution can be kept even. Accordingly, a difference between the highest temperature and the lowest temperature in the energy storage device 100 is reduced and thus the overall temperature distribution is kept even, as shown in FIG. 6 which illustrates a result of a simulation of the energy storage device of the present invention conducted in the same condition as the related art energy storage device.

Also, the energy storage device 100 has the unit cells 110 rotationally stacked at the constant rotation angle so that the positive terminal and the negative terminal are evenly distributed in all directions of the modularized energy storage device, and accordingly, heat transmission efficiency between the positive terminal and the negative terminal and the external air is improved and thus cooling efficiency is improved.

Although not shown in detail, the cell body 113 of the unit cell 110 may include a cathode and an anode stacked sequentially with a separator formed therebetween, and the cathode and the anode may include the positive terminal and the negative terminal, respectively.

The separator may be made of paper or non-woven fabric. However, this should not be considered as limiting. The separator may be made of any material that can electrically separate the cathode from the anode.

The cathode may include a positive current collector and a positive active material layer disposed on each of opposite surfaces of the positive current collector. The anode may include a negative current collector and a negative active material layer disposed on each of opposite surfaces of the negative current collector.

The positive current collector may be integrally formed with the positive terminal 111, and the negative current collector may be integrally formed with the negative terminal 112.

The positive current collector may be made of one of aluminum, stainless, copper, nickel, titanium, tantalum, or niobium. The positive current collector may be 10 to 300 μm thick. Also, the positive current collector may be formed in a thin film shape, but it may include a plurality of penetrating holes to move ions efficiently and achieve an even doping process.

Also, the positive active material layer may include carbon material, that is, active carbon to dope and undope ions reversibly. In addition, the positive active material layer may further include a binder. The binder may be made of one, or two or more of fluoro resin such as poly-tetra-fluoro-ethylene (PTFE) and poly-vinylidene fluoride (PVdF), thermoplastic resin such as polyimide, polyamidimide, polyethylene (PE), and polypropylene (PP), cellulosic resin such as carboxymethylcellulose (CMC), rubber resin such as styrene-butadiene rubber (SBR), terpolymer of ethylene propylene and a diene (EPDM), polydimethylsiloxane (PDMS), and polyvinyl pyrrolidone (PVP).

The negative current collector may include metal, for example, one of copper, nickel, or stainless. The negative current collector may have a thin film shape, but may have a plurality of penetrating holes to move ions efficiently and achieve an even doping process.

Also, the negative active material layer may be used by mixing one, or two or more carbon materials, which dopes and undopes lithium ions reversibly, such as natural graphite, artificial graphite, mesophase pitch based carbon fiber (MCF), mesocarbon microbead (MCMB), graphite whisker, graphitized carbon fiber, non-graphitization carbon, polyacene organic semiconductor, carbon nanotube, compound carbon material of carbon and graphite, pyrolytic material of furfuryl alcohol resin, pyrolytic material of novolac resin, and pyrolytic material of condensed polycyclic hydrocarbon such as pitch and coke.

According to the energy storage device and the manufacturing method thereof, and the unit cell for the energy storage device as described above, there is an advantage that temperature distribution on all of the stacked unit cells can be kept even.

According to the energy storage device and the manufacturing method thereof, and the unit cell for the energy storage device as described above, heat transmission efficiency between the positive terminal and the negative terminal, and the external air can be improved and thus cooling efficiency can be improved.

According to the energy storage device and the manufacturing method thereof, and the unit cell for the energy storage device as described above, a resistance value is reduced by improving a cooling function so that performance and reliability of a product can be ensured.

Although the preferred embodiments of the present invention have been disclosed for illustrative purposes, those skilled in the art will appreciate that various modifications, additions, and substitutions are possible, without departing from the scope and spirit of the invention as disclosed in the accompanying claims. Accordingly, such modifications, additions and substitutions should also be understood to fall within the scope of the present invention.

What is claimed is:

1. An energy storage device comprising a plurality of unit cells stacked therein, each of the unit cells comprising a cell body, a positive terminal disposed at one side of the cell body, and a negative terminal disposed in the cell body to form a constant rotation angle with the positive terminal with reference to a center of the cell body,
wherein the plurality of cell units are stacked in such a manner that another unit cell is rotated as much as the constant rotation angle with reference to one unit cell.

2. The energy storage device according to claim 1, wherein a positive terminal of the one unit cell is connected to a negative terminal of the another unit cell in series, or a negative terminal of the one unit cell is connected to a positive terminal of the another unit cell in series.

3. The energy storage device according to claim 1, wherein, when the another unit cell is rotationally stacked with reference to the one unit cell as much as the constant rotation angle, a cell body of the one unit cell and a cell body of the another unit cell coincide with each other in a stacking direction.

4. The energy storage device according to claim 1, wherein the rotation angle is 90 degrees.

5. The energy storage device according to claim 1, wherein the cell body includes a cathode and an anode stacked in sequence with a separator therebetween, and the cathode and the anode include the positive terminal and the negative terminal, respectively.

6. The energy storage device according to claim 5, wherein the cathode includes a positive current collector and a positive active material layer disposed on each of opposite surfaces of the positive current collector, and the anode includes a negative current collector and a negative active material layer disposed on each of opposite surfaces of the negative current collector.

7. A unit cell for an energy storage device, the unit cell comprising a cell body, a positive terminal disposed at one side of the cell body, and a negative terminal disposed in the cell body to form a constant rotation angle with the positive terminal with reference to a center of the cell body,
wherein the unit cell for the energy storage device configures an energy storage device by stacking a plurality of unit cells in such a manner that another unit cell is rotated as much as the constant rotation angle with reference to one unit cell.

8. A method for manufacturing an energy storage device in which a plurality of unit cells are stacked, each of the plurality of unit cells comprising a cell body, a positive terminal disposed at one side of the cell body, and a negative terminal disposed in the cell body to form a constant rotation angle with the positive terminal with reference to a center of the cell body,
the method comprising stacking the plurality of unit cells in such a manner that another unit cell is rotated as much as the constant rotation angle with reference to one unit cell.
